(19) United States
(12) Patent Application Publication
(10) Pub. No.: US 2005/0084747 A1
(43) Pub. Date: Apr. 21, 2005

(54) Latching mechanism for electronic device and method of assembly

(76) Inventors: Aaron R. Allen, Pembroke Pines, FL (US); Douglas W. Moskowitz, Weston, FL (US); Kevin D. Page, West Palm Beach, FL (US)

Correspondence Address: Scott M. Garrett;Motorola, Inc., Law Department, 8000 West Sunrise Boulevard, Fort Lauderdale, FL, 33322, US

(21) Appl. No.: 10/688,081

(22) Filed: Oct. 17, 2003

(51) Int. Cl. H01M 2/10

(52) U.S. Cl. 429/97

(57) ABSTRACT

A latch mechanism includes a latch member (110) that is assembled into a housing (800) of the device in a direction along a Z axis (906). The latch member has retaining legs (206) that extend though openings (806) in the housing when the latch member is placed in a latch seat (802) of the housing. The openings form guides (808) along which the latch member will move when used. The retaining legs have retaining groves (208) formed in them. A retaining clip (500), which has arms formed into undercut features (502) correspond to the retaining groves of the latch member so that the retaining clip can be slid onto the latch member from an opposite side of the housing which captures the guide between the retaining clip and latch member. The retaining clip is held in place by abutting a component of the device, such as a speaker assembly (812).

### TECHNICAL FIELD

This invention relates in general to portable electronic devices, and more particularly to battery latches for retaining battery packs and battery covers for portable electronic devices.

### BACKGROUND

Portable electronic devices use batteries to provide power to the device during operation. Therefore these devices require a compartment in which to place the battery or battery cells, and a cover to retain the battery. For many of these devices the power consumption is high enough that rechargeable batteries or battery packs are desired to reduce the cost of powering the device. Typically a user will have several rechargeable battery packs so that one can be charged while one is used in the device. Consequently the battery compartment may be opened frequently. Typically battery covers or battery packs are latched into place by a latching mechanism that is both robust, yet easily operable to facilitate easy replacement of the battery by a user of the device.

One conventional arrangement of battery cover/pack and latch is for the cover or pack to connect to the back of the device. The battery pack and/or cover move towards the device, or have one end captivated by features on the device and rotate towards the device. A latch then captures the other end of the battery cover or pack. The latch is biased into a position that captures the cover or pack, and is moveable so that the cover or pack can be removed. In assembling a conventional latch assembly into the device the latching member is placed into the device housing along an axis parallel to the movement of the latch member in normal operation after assembly to be captured by guide and undercut disposed in the housing. That is, the housing has a pair of surfaces that correspond to grooves in the latch member and on which the latch member moves once in place. Because of the way the latch member must be loaded into the housing, the conventional latch design and assembly technique are not optimal for high volume production. Therefore there exists a need for an improved battery latch assembly for a portable electronic device that allows

### BRIEF DESCRIPTION OF THE DRAWINGS

The features of the present invention, which are believed to be novel, are set forth with particularly in the appended claims. The invention, together with further objects and advantages thereof, may best be understood by reference to the following description, taken in conjunction with the accompanying drawings, in the several figures of which like reference numerals identify like elements, and in which:

FIG. 1 is an isometric view of a portable electronic device having a battery latch assembly for latching a battery cover, is accordance with the invention;

FIGS. 2-4 show a front elevational view, bottom plan view, and side elevational view, respectively, of a latch member, in accordance with the invention;

FIGS. 5-6 show a side view and a bottom view, respectively, of a retaining clip for use with a latch assembly in accordance with the invention;

FIG. 7 shows a latch member and retaining clip sub-assembly of a latch assembly, in accordance with the invention;

FIG. 8 shows a portion of a housing of a portable electronic device for supporting the latch assembly, in accordance with the invention;

FIG. 9 shows an exploded isometric view of a latch assembly, in accordance with the invention, and

FIG. 10 shows a side cut-away view of a latch assembly, in accordance with the invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

The invention solves the problem associated with prior art latches and latch assemblies by providing a latch assembly that permits Z axis loading of the latch member. The latch member is retained by a retaining clip and the housing of the portable electronic device. The retaining clip is captured in place between the housing and a component of the device such as a speaker assembly.

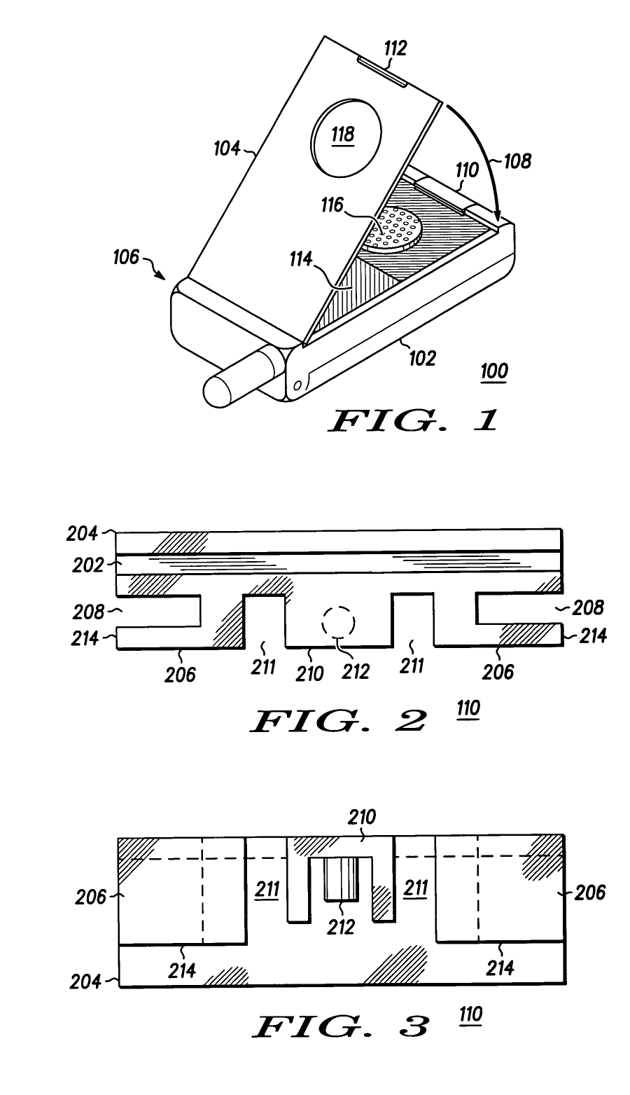

Referring now to FIG. 1, there is shown an isometric view 100 of a portable electronic device 102 having a battery latch assembly for latching a battery cover 104, is accordance with the invention. As shown, the battery cover mates with features at a top end 106 of the device, and rotates downwards as indicated by arrow 108, and is latched into place by a latch member 110 which retains an edge 112 of the battery cover, thereby covering a battery pack 114 disposed in the device. It is contemplated that the battery pack and cover may be integrated together to form a single unit. In the particular embodiment show, the device comprises a speaker assembly 116 mounted on the back of the device. The cover 104 has an opening 118 through which the speaker protrudes. In the preferred embodiment the speaker assembly is used to retain the latch member 110 by means of interference inside the device.

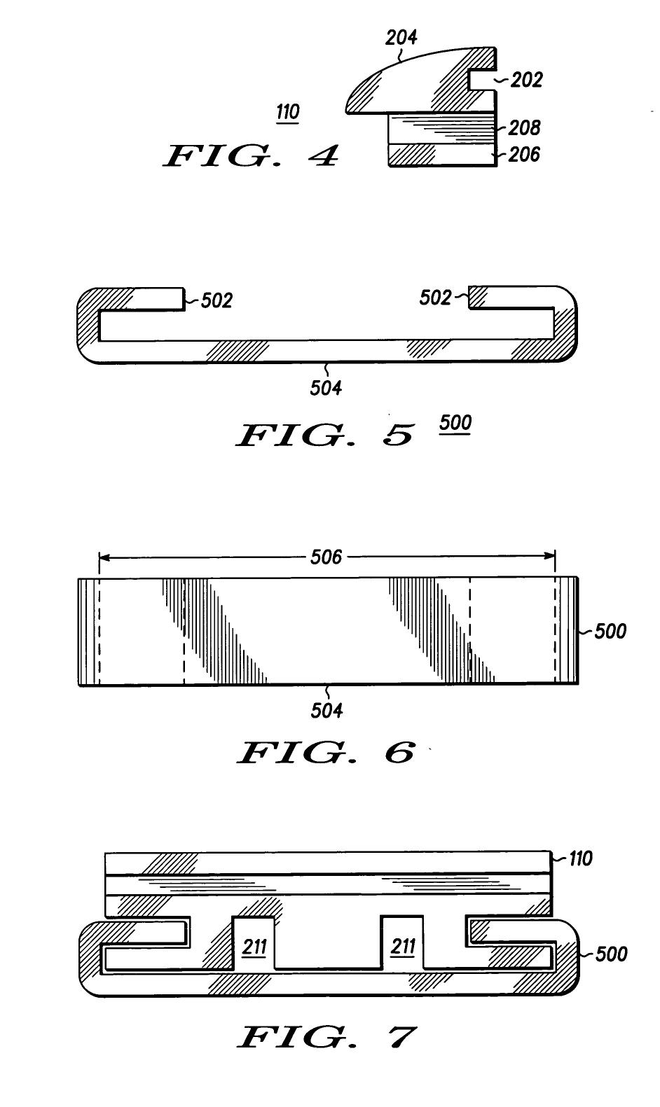

Referring now to FIGS. 2-4, which show a front elevational view, bottom plan view, and side elevational view, respectively, of a latch member 110, in accordance with the invention. The latch member has a retaining grove 202 for retaining the battery cover or battery pack. The retaining groove is cut into the body 204 of the latch member. The groove receives a portion of the cover or battery pack captures it when the latch is moved into a latch position, as will be described herein. The latch member also has a pair of retaining legs 206, each of which is oppositely grooved with a retaining groove 208. By oppositely grooved it is meant that the grooves of each retaining leg face away from each other. Between the retaining legs 206 is a spring mount 210. Between the spring mount and each of the retaining legs is formed a channel 211. The spring mount comprises a mounting post 212 onto which a spring may be mounted for biasing the latch member, as will be described herein. Preferably the latch member is made of a plastic material.

Referring now to FIGS. 5-6, which show a side view and a bottom view, respectively, of a retaining clip 500 for use with a latch assembly in accordance with the invention. The retaining clip is used for retaining the latch member in the portable electronic device, and has a pair of underlocking features 502 which are extensions of the retaining clip folded over the body 504 of the retaining clip body, and spaced away from the retaining clip body. The underlocking features correspond to the retaining grooves 208 of the latch member, and are spaced such that a lower portion 214 of the retaining legs fits into the space between the underlocking features and the body 504 of the retaining clip. The width between the underlocking features (506) corresponds to the distance between the lower portions of the retaining legs of the latch member to ensure proper fit. The retaining clip may be fabricated of a wide variety of materials, and in the preferred embodiment it is made of stamped metal such as steel.

The retaining clip slides onto the latch member as shown in FIG. 7. Referring now to FIG. 7, there is shown a latch member 110 and retaining clip 500 sub-assembly of a latch assembly, in accordance with the invention. From his view it can bee seen that when the retaining clip is assembled onto the latch member, channels 211 form tunnels. Features of the housing will be disposed in these tunnels to guide the latch member and provide a surface on which the retaining clip bears to retain the latch member. Furthermore, the insides of the retaining legs bear on these features to prevent side to side movement.

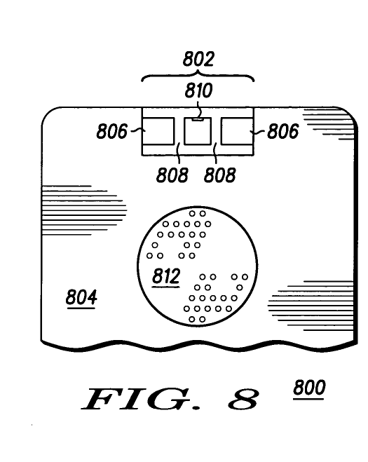

Referring now to FIG. 8, there is shown a portion of a housing 800 of a portable electronic device for supporting the latch assembly, in accordance with the invention. The housing has formed thereon a latch seat 802 which is an area of the housing that is slightly recessed from the back surface 804 of the housing. In the latch seat are openings 806 in the housing. Between the openings are guides 808. The guides 808 are sized and spaced to fit within the channels 211 of the latch member, and between the latch member and the retaining clip. The housing also preferably comprises a spring seat 810, against which a spring means bears to bias the latch member forwards, towards the center of the device, and provide the necessary latching action in holding down a battery pack or battery cover. Furthermore, in the preferred embodiment, there is a speaker assembly 812 mounted in the housing adjacent to the latch seat.

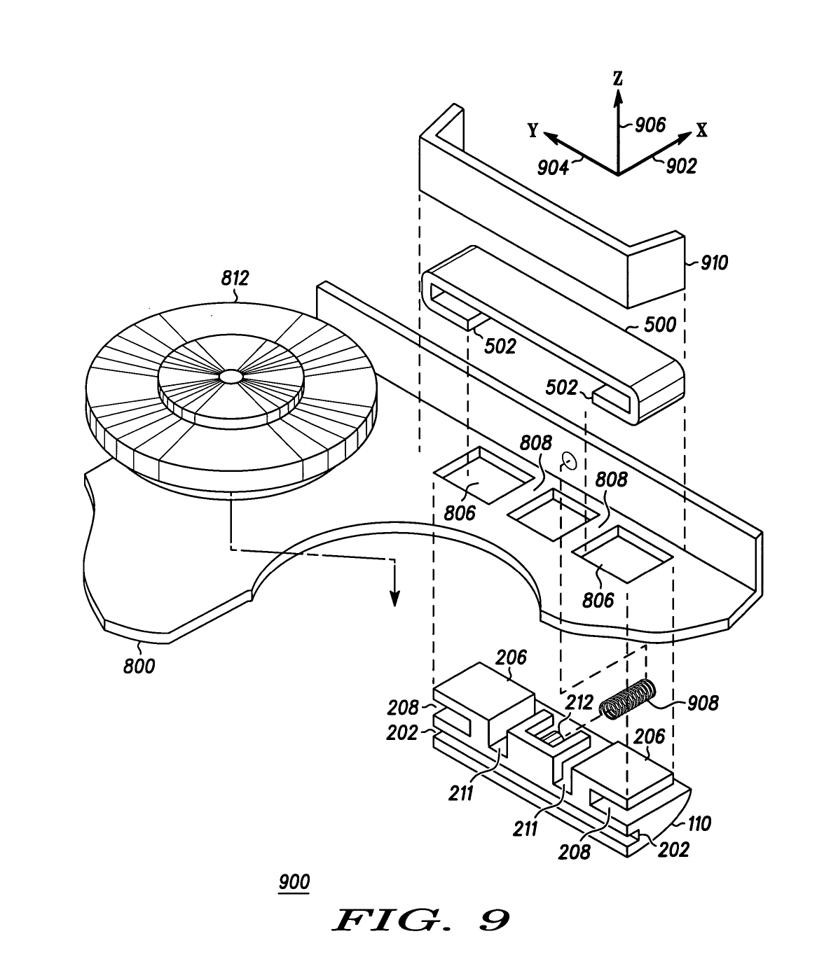

Referring now to FIG. 9, there is shown an exploded isometric view 900 of a latch assembly, in accordance with the invention. In this view the housing 800 is shown from the reverse of the view shown in FIG. 8. In this view three axes are defined; and X axis 902, Y axis 904, and Z axis 906. The housing lies mostly along the X axis and the major surface of the housing lies in a plane defined by the X and Y axes. The latch member 110 is placed into the housing along the Z axis, in the orientation shown, and from the opposite side of the housing in this view. The retaining legs 206 fit through the openings 806 in the housing, which are separated by guides 808. A spring mean 908, such as a steel coil spring, is mounted on the spring mounting post 212 of the spring mount 210, and bears against the back wall in the center opening, held in place by the spring seat 810. The retaining legs are not as wide in the X axis direction as the openings 806, and hence the latch member moves back and forth in the X axis direction. However the spring means biases the latch member towards the center of the housing, away from the spring seat 810.

The latch member 110, once assembled into the housing, is prevented from moving significantly along the Y axis by the retention legs 206 being blocked in the Y axis by the guides 808 in the housing. To retain the latch member in the housing in the Z axis direction the retaining clip 500 is used. Once the latch member is placed in the housing, the retaining legs protrude through the openings 806. The retaining legs 206 are long enough so that the retaining grooves 208 are accessible on the inside of the housing 800. Once in place, the retaining clip 500 can be slid into place, as shown in FIG. 7, with the underlocking features 502 sliding into the retaining grooves 208. The retaining clip is slid into position along the direction of the X axis 902. Thus, the guides 808 prevent the movement of the latch member 110 in the direction of the Y axis, and the guides along with the retaining clip, once in place, prevent movement of the latch member in the direction go the Z axis. The retaining clip 500 is kept in position on the latch member by the rear wall of the housing, and a component of the device, such as the speaker assembly 812. Thus, in the preferred embodiment, after the retaining clip is put in place, the speaker assembly is placed into the housing, thereby capturing the retaining clip between the speaker assembly and the housing. The speaker assembly may be mounted in the housing by any of a variety of known techniques, such as adhesive, or ultrasonic welding, for example. At this point the latch member is in place and the latch assembly is complete. To further retain the retaining clip 500 in place, an adhesive member or strip may be used. The adhesive member may be, for example, on the bottom of an acoustic dam 910. The acoustic dam seals off the latch assembly and a bottom portion of the device from the speaker assembly 812. Typically a connector is disposed at the bottom of the device, and the acoustic dam prevent acoustic waves from exiting the device through the connecter port.

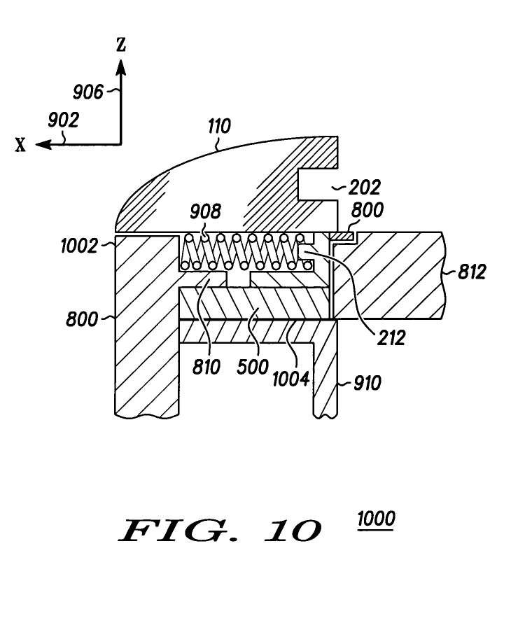

Referring now to FIG. 10, there is shown a side cut-away view 1000 of a latch assembly, in accordance with the invention. In this view the cut is taken along the X axis after the latch assembly is completed through the center of the latch member 110. Here it can be seen that the retaining clip 500 is captivated between the back wall of the housing 800 and the speaker assembly 812. The spring means 908 is mounted on the mounting post 212 at one end and at the other end is captivated between the spring seat 810 and the latch member, bearing against the rear wall 1002 of the housing, and biases the latch member into a latch position. The latch groove 202 is used to captivate an edge of the battery cover or battery pack (not shown here). To release the battery cover or battery pack, the user of the device pushes the latch member away from the battery cover or pack, causing the spring means to be compressed. In assembling the latch assembly, the spring 908 is first mounted on the mounting post 212 of the latch member 110. Then the latch member and spring are set into the housing 800, with the retaining legs extending through the holes 806. The retaining clip 500 is then placed onto the latch member by sliding the underlocking features 502 into the retaining grooves 208. Finally, a component of the device is put in place to captivate the retaining clip in place between the rear wall of the housing and the component. In the preferred embodiment, the component is a speaker assembly 812.

Therefore the invention provides a latching mechanism for latching a battery cover to an electronic device. The electronic device has a housing with a portion of the housing having a latch seat. The latch seat has at least two openings formed therethrough, defining at least one guide. Each guide is a rail member formed along the axis in which the latch member will move for latching and unlatching. Generally the housing has a major surface defining an X-Y plane along X and Y axes, and a Z axis that is normal to the X-Y plane. A latch member is disposed in the latch seat and has a pair of retaining legs extending through the openings along the Z axis. The retaining legs each have a retaining groove. The latch member has a latch groove for retaining the battery used with the electronic device. To hold the latch member in place on the guide or guides, a retaining clip having undercut features is used. The undercut features, or alternatively retaining arms, engage the retaining grooves of the latch member in a slideable fashion, along an axis parallel to the X-Y axis. Once in place, the retaining clip captures the guide or guides between the retaining clip and the latch member, thereby retaining the latch member in the latch seat. The retaining clip is in turn held in place by a means such as by abutting a component of the device, such as a speaker assembly, or by an adhesive member such as that disposed on the bottom of an acoustic dam placed over the retaining clip, or both. Furthermore, a spring means is used for biasing the latch member into a latch position. The spring means may be, for example, a coil spring or a cantilevered member, as is known in the art. One advantage of the latch assembly is that it facilitates easy assembly of the latch mechanism into the device. The main significance is in placing the latch member into the latch seat along the Z axis, and then placing the retaining clip onto the latch member from an opposite side of the housing.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A latching mechanism for latching a battery cover to an electronic device, comprising:
a portion of a housing of the electronic device having a latch seat, the latch seat having at least two openings therethrough defining at least one guide;
a latch member disposed in the latch seat and having a pair of retaining legs extending through the openings, the retaining legs each having a retaining groove, the latch member having a latch groove for retaining a battery for use with the electronic device;
a retaining clip having undercut features for engaging the retaining grooves of the latch member, for capturing the at least one guide between the retaining clip and the latch member, thereby retaining the latch member in the latch seat;
means for holding the retaining clip in place in the housing; and
spring means for biasing the latch member into a latch position.

2. A latching mechanism as defined in claim 1, wherein the at least one guide comprises two guides.

3. A latching mechanism as defined in claim 1, wherein the latch member further comprises a spring mount, the spring means is a coil spring mounted on the spring mount.

4. A latching mechanism as defined in claim 1, wherein the means for holding the retaining clip in place in the housing comprises a component of the electronic device.

5. A latching mechanism as defined in claim 4, wherein the component of the electronic device is a speaker assembly.

6. A latching mechanism as defined in claim 1, wherein the means for holding the retaining clip in place in the housing comprises an adhesive member placed over the retaining clip.

7. A latching mechanism as defined in claim 6, wherein the adhesive member is an acoustic dam.

8. A battery latch for a mobile communication device having a housing, a portion of a housing of the electronic device having a latch seat, the latch seat having at least two openings therethrough defining at least one guide, the battery latch comprising:
a latch member disposed in the latch seat and having a pair of retaining legs extending through the openings, the retaining legs each having a retaining groove, the latch member having a latch groove for retaining a battery for use with the electronic device;
a retaining clip having undercut features for engaging the retaining grooves of the latch member, for capturing the at least one guide between the retaining clip and the latch member, thereby retaining the latch member in the latch seat;
means for holding the retaining clip in place in the housing; and
spring means for biasing the latch member into a latch position;
wherein the a major surface of the housing defines an X-Y plane.

9. A battery latch as defined in claim 8, wherein the at least one guide comprises two guides.

10. A battery latch as defined in claim 8, wherein the latch member further comprises a spring mount, the spring means is a coil spring mounted on the spring mount.

11. A battery latch as defined in claim 8, wherein the means for holding the retaining clip in place in the housing comprises a component of the electronic device.

12. A battery latch as defined in claim 11, wherein the component of the electronic device is a speaker assembly.

13. A battery latch as defined in claim 8, wherein the means for holding the retaining clip in place in the housing comprises an adhesive member placed over the retaining clip.

14. A battery latch as defined in claim 13, wherein the adhesive member is an acoustic dam.

15. A method of assembling a battery latch for a mobile communication device, the mobile communication device having a housing having a major surface defining an X-Y plane, a Z axis being defined in a direction normal to the X-Y plane, the method comprising:
providing on the housing a latch seat having a plurality of openings through the housing, and wherein at least one guide is defined between the openings;
placing a latch member into the latch seat along the Z axis, the latch member having at least two retaining legs which fit through the openings in the housing, the retaining legs having retaining groves, the retaining groves being substantially parallel to the X-Y plane;
placing a retaining clip onto the latch member from an opposite side of the housing, the retaining clip having undercut features which slide into the retaining groves along an X axis; and
placing a retaining feature in contact with the retaining clip to hold the retaining clip in place.

16. A method of assembling a battery latch as defined by claim 15, wherein placing the retaining feature in contact with the retaining clip comprises placing an adhesive member in contact with the retaining clip.

17. A method of assembling a battery latch as defined by claim 16, wherein placing the adhesive member in contact with the retaining clip comprises placing an acoustic dam in contact with the retaining clip.

18. A method of assembling a battery latch as defined by claim 15, wherein placing the retaining feature in contact with the retaining clip comprises placing a component of the mobile communication device in contact with the retaining clip.

19. A method of assembling a battery latch as defined by claim 18, wherein placing the component in contact with the retaining clip comprises placing a speaker assembly of the mobile communication device in contact with the retaining clip.
